(19) United States
(12) Patent Application Publication
(10) Pub. No.: US 2016/0323235 A1
(43) Pub. Date: Nov. 3, 2016

(54) Instant Message and Electronic Mail Portability

(71) Applicant: D2 Nova Corp., Santa Barbara, CA (US)

(72) Inventors: David Lindsay, Santa Barbara, CA (US); David Y. Wong, Santa Barbara, CA (US)

(21) Appl. No.: 15/134,039

(22) Filed: Apr. 20, 2016

Related U.S. Application Data
(60) Provisional application No. 62/154,488, filed on Apr. 29, 2015.

(51) Int. Cl. H04L 12/58

(52) U.S. Cl. CPC H04L 51/36; H04L 51/04

(57) ABSTRACT

Systems and methods for migrating an email conversation to an instant message (IM) chat session are provided herein. Exemplary methods include receiving an email request from an email client via one or more email servers, the email request having the email conversation and an address that initiates an action to instantiate the IM chat session of an IM service; identifying a sender and recipients from the email request; verifying that the sender is authorized to create the IM chat session and that the recipients are authorized to participate in the IM chat session; transmitting an IM request to the IM service via an IM server to establish the IM chat session, wherein the IM service invites the sender and the recipients when the IM chat session is created; and maintaining the IM chat session for responding parties.

### CROSS-REFERENCE TO RELATED APPLICATIONS

This application claims the priority benefit of U.S. Provisional Application Ser. No. 62/154,488, filed on Apr. 29, 2015, entitled “Instant Message and Electronic Mail Portability,” which is hereby incorporated by reference in its entirety, including all references cited therein.

### FIELD

The present technology pertains to messaging services and electronic mail, and more particularly but not by limitation to methods and systems for transferring electronic mail session to instant message session and vice-versa.

### BACKGROUND

It should not be assumed that any of the approaches described in this section qualify as prior art merely by virtue of their inclusion in this section.

Email and Instant Messaging (IM) are two of the most popular communication methods used today on computers and mobile devices, such as smart phones or tablets. Before the introduction of IM, email was often used by multiple users as a means of conducting a dialog or discussion by using the “reply-all” to begin an “email chain.” Such an email chain is often better served by an IM service. However, email and IM are usually completely separate applications that do not communicate with each other. This makes it difficult for users to transition a conversation from email to IM, or to continue an IM via email or to receive email updates on the IM session. Unfortunately, this deficiency has not been solved and has never been addressed previously.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Some embodiments of the present disclosure include methods for migrating an email conversation to an instant message (IM) chat session which may include: receiving, by a processor, an email request from an email client via one or more email servers, wherein the email request comprises the email conversation and an address that initiates an action to instantiate the IM chat session of an IM service; identifying, by the processor, a sender and one or more recipients from at least the email request and the email conversation; verifying, by the processor, that the sender is authorized to create the IM chat session and that the one or more recipients are authorized to participate in the IM chat session; transmitting, by the processor, an IM request to the IM service via an IM server to establish the IM chat session, the IM request having a plurality of IM service accounts associated with the sender and the one or more recipients, wherein the IM service invites the sender and the one or more recipients when the IM chat session is created; receiving, by the IM server, responses from the sender and the one or more recipients to the invite; and maintaining, by the IM server, the IM chat session for responding parties.

Various embodiments of the present disclosure include systems for migrating an email conversation to an IM chat session comprising: a processor; and a memory coupled to the processor, the memory storing instructions which are executable by the processor to perform a method comprising: receiving an email request from an email client via one or more email servers, wherein the email request comprises the email conversation and an address that initiates an action to instantiate the IM chat session of an IM service; identifying a sender and one or more recipients from at least the email request and the email conversation; verifying that the sender is authorized to create the IM chat session and that the one or more recipients are authorized to participate in the IM chat session; transmitting an IM request to the IM service via an IM server to establish the IM chat session, the IM request having a plurality of IM service accounts associated with the sender and the one or more recipients, wherein the IM service invites the sender and the one or more recipients when the IM chat session is created; receiving responses from the sender and the one or more recipients to the invite; and maintaining the IM chat session for responding parties.

In some embodiments, the present disclosure includes non-transitory computer readable storage media having embodied thereon a program, the program being executable by a processor to perform a method for migrating an email conversation to an instant message (IM) chat session, the method comprising: receiving an email request from an email client via one or more email servers, wherein the email request comprises the email conversation and an address that initiates an action to instantiate the IM chat session of an IM service; identifying a sender and one or more recipients from at least the email request and the email conversation; verifying that the sender is authorized to create the IM chat session and that the one or more recipients are authorized to participate in the IM chat session; transmitting an IM request to the IM service via an IM server to establish the IM chat session, the IM request having a plurality of IM service accounts associated with the sender and the one or more recipients, wherein the IM service invites the sender and the one or more recipients when the IM chat session is created; receiving responses from the sender and the one or more recipients to the invite; and maintaining the IM chat session for responding parties.

### BRIEF DESCRIPTION OF THE DRAWINGS

The accompanying drawings, where like reference numerals refer to identical or functionally similar elements throughout the separate views, together with the detailed description below, are incorporated in and form part of the specification, and serve to further illustrate embodiments of concepts that include the claimed disclosure, and explain various principles and advantages of those embodiments.

The methods and systems disclosed herein have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

FIG. 1 is a schematic diagram of an exemplary computing architecture that can be used to practice aspects of the present technology.

FIG. 2 illustrates an exemplary message sequence diagram for migrating an email conversation to an instant message chat session, in accordance with some example embodiments.

FIG. 3 is schematic diagram of another exemplary computing architecture that can be used to practice aspects of the present technology.

FIG. 4 illustrates a flow chart illustrating a method for migrating an email conversation to an instant message chat session, in accordance to the present technology.

FIG. 5 illustrates an exemplary computing system that may be used to implement embodiments according to the present technology.

### DETAILED DESCRIPTION

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated.

The terminology used herein is for the purpose of describing particular embodiments only and is not intended to be limiting of the technology. As used herein, the singular forms “a”, an and the are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that like or analogous elements and/or components, referred to herein, may be identified throughout the drawings with like reference characters. It will be further understood that several of the figures are merely schematic representations of the present technology. As such, some of the components may have been distorted from their actual scale for pictorial clarity.

Several methods to create a new chat from email are described herein. These methods include, but are not limited to, a method that comprises sending an email to a gateway for the IM service, and allowing a participant of an email conversation to directly create a chat from the email software client. This and other example methods and system are described in greater detail herein.

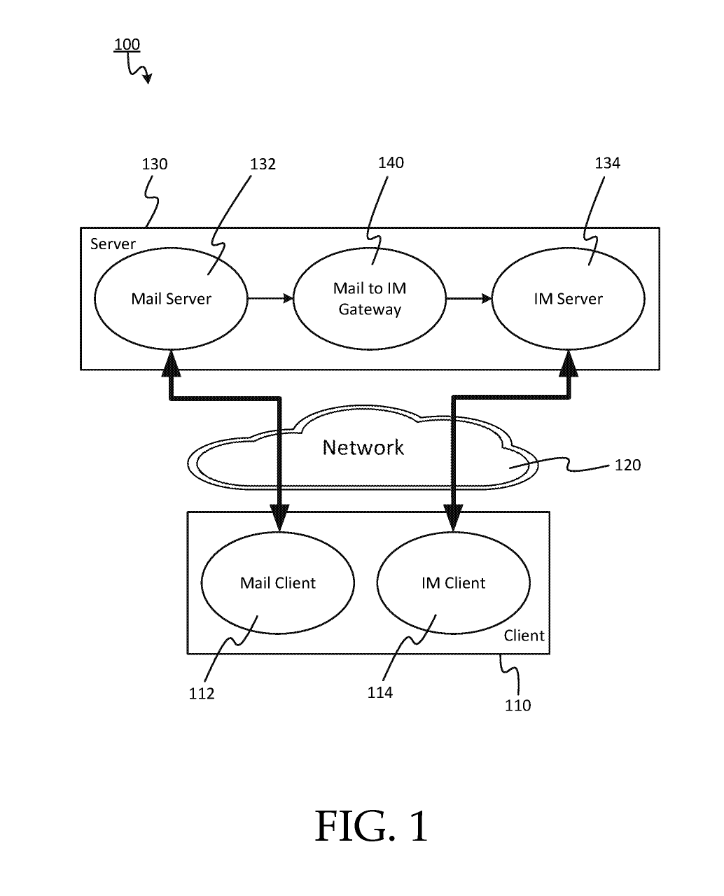

FIG. 1 illustrates an exemplary architecture for practicing aspects of the present technology. The architecture comprises a system, hereinafter “system 100,” that is configured to provide various functionalities, which are described in greater detail throughout this document. In general, the system provides for cross compatibility and conversion from email conversations to instant messaging (IM) conversations and, in some embodiments, from IM conversations to email conversations.

The system 100 can include a session initiation protocol (SIP) server, an extensible messaging and presence protocol system (XMPP), a web real-time communication system (WebRTC), a voice over Internet protocol system (VoIP), as well as other call and messaging systems utilizing HTTP, RESTful APIs, JSON, WebSocket, and other protocols that would be known to one of ordinary skill in the art.

In some embodiments, the system 100 can be utilized to migrate a conversation from email to IM by providing a component that bridges the two services (email and IM). In some embodiments, the component includes a gateway approach.

For purposes of clarity, FIG. 1 illustrates a simplified system where any mail server 132 and IM server 134 can be configured to provide the email to IM and IM to email migrations described herein. The system 100 comprises a server 130 and client 110. The server 130 and client 110 can communicate with one another over a network 120.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks like LTE, 2G/3G/4G, etc., GPS (Global Positioning System), CDPD (cellular digital packet data), RIM (Research in Motion, Limited) duplex paging network, Bluetooth radio, or an IEEE 802.11-based radio frequency network. The network can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

The server 130 can comprise a mail server 132, an IM server 134, and a Mail to IM gateway 140. It will be understood that the gateway can be utilized to migrate between email and IM, as well as from IM to email. In some instances, conversations or individual messages can be migrated back and forth between email and IM as desired.

In various embodiments the components of the server 130 are collocated on the same server or within a cloud-computing environment. In other embodiments, part or all of the components of the server 130 are distributed apart from one another. In some embodiments, the server 130 can implement only the gateway 140, which can be configured to provide migration features between any email server and any IM server that are configured to support the message migration features described herein.

Before introducing the elements needed to create a chat from an email conversation, consider the following usage scenario: An email user, identified in FIG. 1 as using the client 110, is reading a threaded conversation and decides that the conversation would proceed more efficiently as an IM chat session. In order to start this new chat, the following sequence of actions is taken by the client 110 and the migration system 100.

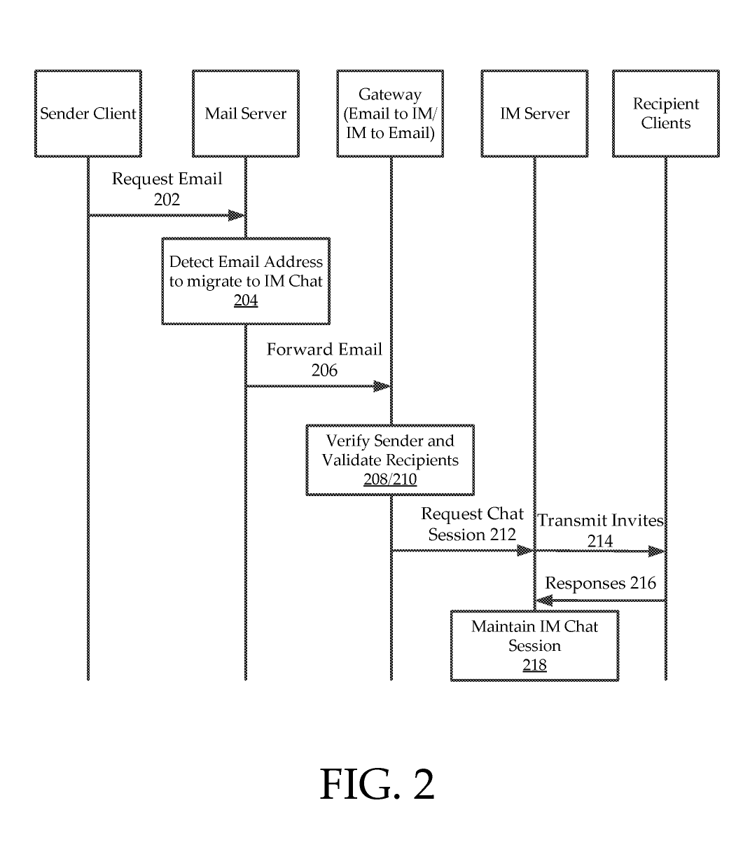

FIG. 2 illustrates the sequence of actions 200 in the migration process in the form of a signal flow diagram. In some embodiments, the sender client 110 forwards 202 the email message to a special address such as newgroupchat@im.provider.net. The exact composition of the special address can be varied so long as the email allows the mail server 132 to forward/transmit the email address to the gateway 140 or other component responsible for migration.

To be sure, the email server detects 204 that this address is associated with an action to start a chat on an associated IM service. The email server forwards 206 the email message to the email to IM gateway. In some embodiments, the mail to IM gateway 140 is a script or a daemon that is purpose-built to processes the message. In some embodiments the email to IM gateway is a server or VM that is programmed to provide the migration features described herein.

The mail to IM gateway 140 receives the message and verifies 208 that the sender is authorized to create an IM chat for the specified IM service.

The gateway then validates 210 that all of the recipients have valid accounts with the IM server 134. If not, the gateway 140 attempts to associate the recipients without valid accounts with guest accounts. To be sure, the members of the group chat are the recipients of the email. The gateway can determine the recipients from email address located either in the header portion of the email or found within an email message string.

The gateway 140 then contacts the IM server 134 and requests 212 that a group chat be created. In some optional embodiments, the subject of the group chat is extracted from the subject of the email and utilized within the IM chat session.

After the IM server 134 has created the chat, the IM server 134 invites 214 all of the email recipients to the chat as members of the chat. Once a member accepts the invitation, they can continue the conversation using the IM service, provided by the IM server 134.

In some embodiments, one or more of the recipients respond 216 to the invitation. The IM service then maintains 218 an IM chat session for the invited and responding parties. The parties can request migration of the IM chat session back to email, as will be described in greater detail below. Alternatively, the IM service can terminate the IM chat session upon request of the parties in the IM chat session. In some embodiments, any of the responding parties, either a recipient or the sender can request a termination or tear down of the IM chat session.

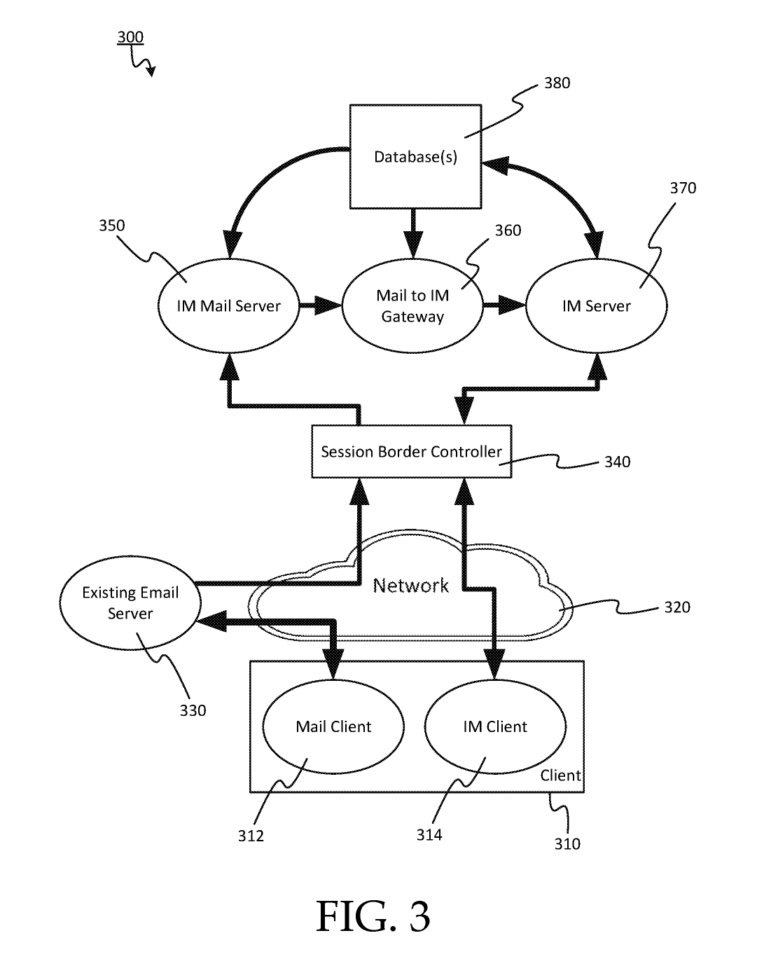

FIG. 3 illustrates another example system 300 that can be utilized to practice the present technology. In order to get more rapid acceptance of this approach to integrating email and IM, the implementation can take advantage of existing email and IM servers. To be sure, most users have a favorite email client that is used to access existing email accounts at an existing email service. The user can advantageously continue using their preferred email service and email client.

In order to use IM, the user may use any IM client that is configured to utilize the IM service supported by the gateway. Although the FIG. 1 shows the email and IM clients as separate applications, it is not required that they be separate, although for purposes of brevity and clarity, the following paragraphs describe the operations as if they are separate applications.

According to some embodiments, the user utilizes an email client 312 that exchanges email with an existing email server 330 and an IM client 314 that communicates with a separate IM service via an IM server 370. The existing mail server 330 comprises the preferred email service utilized by the end user. As far as the user is concerned, these are the only servers with which his clients need compatibility.

In addition to the system components in FIG. 1, FIG. 3 includes additional elements such as databases 380, a session border controller 340, and the legacy or existing mail server 330. The databases 380 are configured to store various types of data that are required for implementation of the message migration process of the system 300. For example, data is shared between the IM server 370, a mail to IM gateway 360, and the IM mail server 350. For efficiency, the databases 380 can be separated for each of the IM server 370, IM gateway 360, and the IM email server 350 to increase scalability.

The session border controller 340 can be utilized to secure the private network where the IM server 370, IM gateway 360, and the IM email server 350 reside, in such a way that these elements are not directly exposed to any public networks, such as the Internet.

In an example operation, when the user wishes to create a chat from an existing email discussion, the user informs the email client 312 to forward the message via the existing mail server 330 to the IM mail server 350 through the session border controller 340.

In order for the existing mail server 330 to accomplish this task, the request to create a chat is relayed by the existing mail server 330. Each request to create a new session is created by forwarding the email to a special address associated with the IM server elements 350, 360 and 370 that convert email discussions to IM chats.

As mentioned above, the email can be forwarded to a special recipient, such as newgroupchat@im.provider.net. The email address for the domain, im.provider.net, is resolved to the IM mail server 350 that is responsible for initiating the process that creates the IM chat.

In some embodiments, the address is arbitrary. To be sure, it is advantageous that the existing mail server 330 be configured to forward the request from the user to the IM mail server 350. In some embodiments, this functionality is accomplished by sending email to a pre-specified recipient in a pre-specified domain. The existing mail server 330 need not be aware that it is creating an IM chat.

Once the email reaches the IM mail server 350, it is processed to create an IM session. There are a number of email servers that can be used to process the email. One very common and very configurable server is Sendmail. Sendmail can be configured to run a script when it receives email to a particular recipient. In this case, it can forward the message to the mail to IM gateway 360.

Once the mail to IM gateway 360 receives the email, the IM gateway 360 performs a check to determine if the sender is a valid IM user using a database 380 that is shared with the IM server 370. If the sender is not a valid user, the gateway 360 rejects the message. If the sender is valid, the IM gateway 360 checks the email recipient list and validates that each recipient has a valid IM account. For all valid recipients, the mail to IM gateway 360 contacts the IM server 370 and initiates a group chat with the sender and the valid recipients. The subject of the group chat can be extracted from the subject of the email.

The system described in FIG. 3 is not restricted to just creating an IM chat. The system 300 can also be configured to place additional information in the IM chat. For example, the mail to IM gateway 360 could parse the message body and add any text to the chat and any attachments as file transfers.

When the mail to IM gateway 360 creates the chat, the IM server 370 sends invitations to all (or at least a portion) of the participants. Once a user accepts the IM chat, they can join the IM chat.

Using the approach described in this section, the system 300 can be implemented on a single server for a small installation or distributed across a number of servers for large scale installation.

In some embodiments, the client can implement certain procedures that allow the client to conduct the message migration process. For example, in order to make the process easier for the user, the forwarding recipient address can be added as a “contact” either by the user or by the administrator of the existing mail service 330. The user can select this address from their contact list when initiating a process to migrate an email conversation to IM.

In addition to making the mechanics easier, a Uniform Resource Identifier (URL), or in some embodiments an email address, used when forwarding the email can be constructed in a way that makes clear to the user that they are creating a new IM chat. Since no formal URL structure is required, the URL can be created in a user friendly manner. The only requirement is that the URL directs the email to the IM mail server 350. However, there are a couple of user friendly approaches to naming the URL. In some embodiments, the user name portion of the URL can be something simple like chat or the product name (e.g. IM). The root of the domain name can be based on the service provider's domain, which allows the service provider's Domain Name System (DNS) server to resolve the domain. A subdomain (if utilized) can contain the service (e.g. IM). In some embodiments, the DNS server for the corporation's domain can be used to supply an alias for the canonical domain name for the IM mail server 350.

Non-limiting examples of URLs include: (1) newgroup@im.provider.net could be the URL that would be routed to the IM mail sever 350 and used to create a new chat for service provider name provider; and (2) newgroup@companyX.provider.net could be the URL that would be routed to the IM mail server 350 and used to create a new chat for service provider name provider and further distinguish that the email is specifically meant to create an IM for Company users; and (3) newgroup@im.companyX.com could be an alias used to create a new group chat for Company X users. This URL is an alias for the actual IM email server (e.g., newgroup@im.provider.net).

In some embodiments, the specific and unique URL or email address of the email request, on which the email was received, corresponds to a specific IM chat session, such that subsequent emails to that specific URL or email address result in additional IM messages to be added to that specific IM chat session.

In other embodiments, the URL or email address of the email request, on which the email was received, corresponds to a specific IM chat user, such that the initiator of the IM chat session is determined and validated to be the author of the email.

In another approach, it is understood that while many users prefer to use web based email clients, there exists a large community (such as enterprise users) that utilize email programs like Outlook™. Such desktop email clients allow third parties to add new functions by using extensions or plugins.

In order to make the creation of chats more user friendly, plugins can be added to these email clients that perform the operations needed to create (migrate) the IM chats from email conversations. The following sections describe different approaches to the plugins.

In other embodiments, a plugin is created that allows a user to forward an email message to the IM mail server 350. Using this type of plugin eliminates the need for the user to forward the message and address it to the IM mail server 350. Basically, this is a convenience method that eliminates (or automates) IM mail server receipt and transmission steps described above.

Since plugins can be written to perform complex operations, it is not necessary for the email program to forward a message to create the IM chat. The email program plugin could contact the IM server 370 (in FIG. 3) directly to request a new chat session.

Two example methods for creating a chat without forwarding an email message are provided below. In one example method, the email program could directly communicate with an IM client 314 on the same computer or mobile device to create the chat session. The IM client 314 on the same computer or mobile device provides an interface that allows the email client 312 to request a new group chat. The IM client 314, in this embodiment, is configured by registration and execution on the same device as the email program/client.

In other embodiments, a request for the IM server 370 to create a group chat can be implemented. The mail program/client plugin directly contacts the IM server 370. The plugin authenticates with the IM server 370 and uses the same or similar protocols as the IM client 314. Examples of these protocols are SIP, XMPP or WebRTC based messaging, as mentioned above.

When the user activates the plugin to create the IM chat, the plugin follows a standard protocol flow to create the IM chat. For example, if the server is using SIP, the plugin authenticates and sends an invitation to the participants in the group chat. The IM server 370 responds by creating the chat and sends an acknowledgement. If the IM server 370 has multi-device support, the user can continue the chat on their IM client 314 (on any device).

In another example, if the plugin directly contacts the IM server 370, this would eliminate the need to for an IM mail server 350 and gateway 360 to setup the group chat. In these embodiments, the plugin will need to have all the necessary protocol support to register and create the chat with the IM server 370 directly. Since communications must be authenticated, the plugin will need to be able to gain access to the IM server 370 on behalf of the user or subscriber (e.g. by using the user name and password).

While the paragraphs above have dealt with processes for migrating email conversations to IM chat sessions, the present technology can be utilized to convert/migrate IM chat sessions into email conversations, and to convert individual IM messages into individual email messages.

Most operating systems allow a user to copy a block of text from one application into another application. For example, a user can create an email by copying a block of text from an IM application and pasting the text into the email. If the user wants to attach a file to that message, the user will specify for the email application the location of the file. The email application copies the file from the file systems and encodes the file into the email message. In the same way, the systems described above can be used to create an email from an IM chat.

By applying the process described in the previous section in reverse, the IM client 314 can be used to send a message based on the content in the IM chat. For example, the user may want to share some or all of the chat items via an email. The user selects the items that are to be sent, which can be text items, images, or files. The client prompts the user for the subject of the email and the addresses of the recipients. After the user has entered the data, the user commands the IM client 314 to send the email.

The IM client 314 can command the IM server 370 to send an email several different ways. In some embodiments, the IM protocol (e.g. SIP, XMPP) can be modified to support an extension that tells the server that the current message should be routed over email. For example, a new SIP method can be added to the standard SIP methods.

The client application can use the SIP INFO method to command the server 370 to send an email. To be sure, the SIP INFO message was designed to allow applications to embed information in a SIP dialog. Short email transmissions can be adapted to use this approach. However this approach is not appropriate for a long message or one that contains a file attachment.

In these embodiments, a new multi-purpose Internet mail extensions (MIME) type can be created that commands the server 370 to transfer a file that contains an email message to a gateway creates and send the email. This would require that the server checks the MIME type of each file transfer and routes the ones with the appropriate MIME type to the IM to mail gateway (illustrated above in FIGS. 1 and 3 as mail to IM gateway 360).

A new SIP session could be created that tags the invitation with information that tells the IM server 370 that the SIP session is intended for the IM to Mail gateway 360. The gateway 360 can accept the session and use message or file transfer techniques to get the subject, recipients and message body.

IM messages can be encoded as XML or JSON documents. The documents can be used to describe the message. The documents include information for setting the email subject, the recipient list, and the message body. In certain embodiments, the information describes the message in such a way that the email body is created from the message store located on the database server 380. For messages that contain large amounts of text and files, the IM client 314 can send a small message to the IM server 370 indicating where the body of the intended email is stored, so that the IM server 370 can create the email by copying the content of the messages and files from the database 380.

All of the methods described above will allow the IM client 314 to command the IM server 370 to send an email. The method selected may depend on network bandwidth used by the command, the impact on the client application (complexity, memory, and other limited resources) and the resource limitations of the servers behind the session border controller.

In some embodiments, the email session created from an existing IM chat session will require encoding. For example, in order to create new email thread from an existing IM chat, the IM chat is converted, in some embodiments, to a format that is understood by the existing email server 330. An email message body is encoded as multipart MIME message. This format allows mail messages to contain both plain text messages as well as files. Encoding can be done by either the IM client 314 or in a server (such as the IM server 370 or gateway 360).

If the IM server 370 or gateway 360 is configured to provide encoding, the selected element can utilize one of the previously described command methods to send the subject of the message, the recipient list, and the contents of the message body. If the client sends the database locations for the contents, the IM server 370 or gateway 360 can access the different elements from the database 380 and encode them in a multipart MIME message.

If the IM client 314 does the encoding, it must have access to all of the information (files and text). The IM client 314 can create the multipart MIME message and send it as a file to the gateway 360. This can be done as a file transfer to the Mail to IM gateway 360 or as a special type of file transfer that the IM server 370 routes to the gateway 360.

According to other embodiments, many operating systems allow an application to direct a message to an email client running on the same device. For example, the Android™ operating system allows a user to use a mail client to send a message using the default mail application. Typically, a default email account is used. For users that have multiple email accounts on the device, the email may come from a personal account rather than a business account. To be sure, this approach may not be available on all devices.

One problem that user may encounter is that the email generated by the IM service 370 is incorrectly recognized as SPAM. To overcome this issue, the address sent to the IM mail server 350 can be added by the user or the administrator as a safe sender in the existing mail server 330 or mail client 312, so that any emails generated by the IM server 370 would not be blocked.

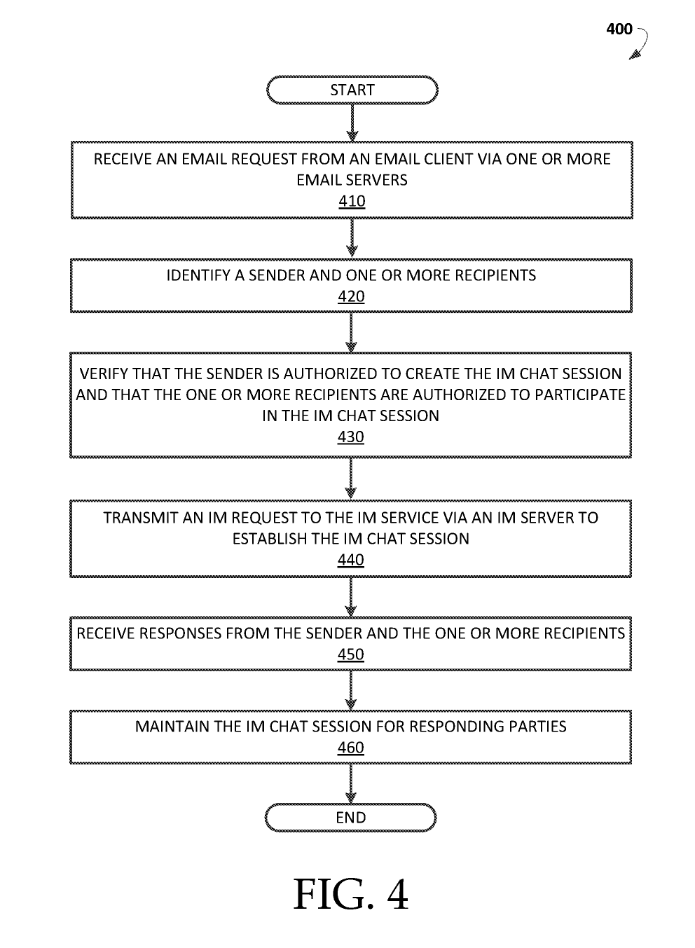

FIG. 4 is a process flow diagram, illustrating a method 400 for migrating an email conversation to an IM chat session, in accordance to the present technology. The method 400 may commence with receiving, by a processor, an email request from an email client via one or more client servers, at operation 410. In various embodiments, the email request includes the email conversation and an address that initiates an action to instantiate the IM chat session of an IM service. In certain embodiments, the email conversation is parsed by the processor to obtain a body of the email conversation, which may be further parsed into a plurality of email replies and file attachments. The IM request then further comprises the body of the email conversation, the plurality of email replies, and the file attachments.

At operation 420, a sender and one or more recipients are identified by the processor. In certain embodiments, the sender and the one or more recipients are identified from at least the email request and the email conversation.

At operation 430, the method 400 proceeds with verifying, by the processor, that the sender is authorized to create the IM chat session and that the one or more recipients are authorized to participate in the IM chat session. In certain embodiments, guest IM service accounts are generated for at least one of the one or more recipients that requires a new IM service account, the guest IM service account being temporarily associated with the at least one or more recipients.

At operation 440, an IM request is transmitted by the processor to the IM service via an IM server to establish the IM chat session. In some embodiments, the IM request has a plurality of IM service accounts associated with the sender and the one or more recipients and the IM service invites the sender and the one or more recipients when the IM chat session is created. The IM request may further comprise a title of the IM chat session, the title determined from a subject of the email conversation. In certain embodiments, the IM server adds the body of the email conversation to the IM chat session as a message when the IM chat session is created. The IM server may also add each email reply of the plurality of email replies as a separate message, and each file attachment as a file transfer.

At operation 450, responses from the sender and the one or more recipients to the invite are received by the IM server. At operation 460, the IM chat session is maintained by the IM server for responding parties.

In one or more embodiments, the method 400 further comprises receiving a second email request from the email client via the one or more email servers, the second email request having one or more additional emails associated with the email conversation. A second IM request is then transmitted to the IM service via the IM server, the second IM request having a body of each of the one or more additional emails, wherein the IM service adds each body to the IM chat session as an additional message.

In other embodiments, the method 400 is extensible to add unique and separate groups of users (for example, as different companies or teams using the IM service), such that one group of users has isolated IM conversations and email integrations than the other groups. In this way, different groups of users have separate IM chat sessions.

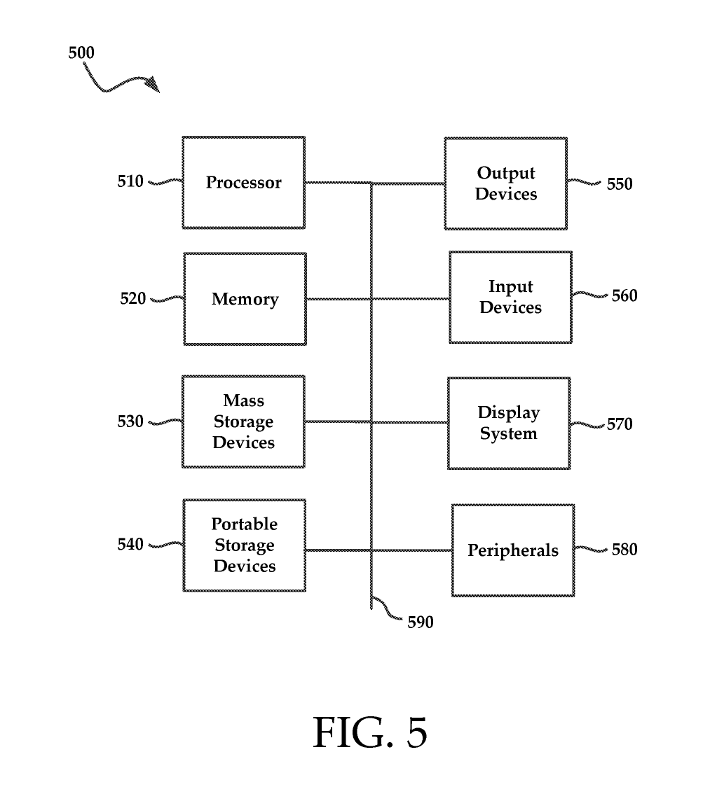

FIG. 5 illustrates an exemplary computer system 500 that may be used to implement some embodiments of the present invention. The computer system 500 of FIG. 5 may be implemented in the contexts of the likes of computing systems, networks, servers, or combinations thereof. The computer system 500 of FIG. 5 includes one or more processor units 510 and main memory 520. Main memory 520 stores, in part, instructions and data for execution by processor units 510. Main memory 520 stores the executable code when in operation, in this example. The computer system 500 of FIG. 5 further includes a mass data storage 530, portable storage device 540, output devices 550, user input devices 560, a graphics display system 570, and peripheral devices 580.

The components shown in FIG. 5 are depicted as being connected via a single bus 590. The components may be connected through one or more data transport means. Processor unit 510 and main memory 520 is connected via a local microprocessor bus, and the mass data storage 530, peripheral device(s) 580, portable storage device 540, and graphics display system 570 are connected via one or more input/output (I/O) buses.

Mass data storage 530, which can be implemented with a magnetic disk drive, solid state drive, or an optical disk drive, is a non-volatile storage device for storing data and instructions for use by processor unit 510. Mass data storage 530 stores the system software for implementing embodiments of the present disclosure for purposes of loading that software into main memory 520.

Portable storage device 540 operates in conjunction with a portable non-volatile storage medium, such as a flash drive, floppy disk, compact disk, digital video disc, or Universal Serial Bus (USB) storage device, to input and output data and code to and from the computer system 500 of FIG. 5. The system software for implementing embodiments of the present disclosure is stored on such a portable medium and input to the computer system 500 via the portable storage device 540.

User input devices 560 can provide a portion of a user interface. User input devices 560 may include one or more microphones, an alphanumeric keypad, such as a keyboard, for inputting alphanumeric and other information, or a pointing device, such as a mouse, a trackball, stylus, or cursor direction keys. User input devices 560 can also include a touchscreen. Additionally, the computer system 500 as shown in FIG. 5 includes output devices 550. Suitable output devices 550 include speakers, printers, network interfaces, and monitors.

Graphics display system 570 include a liquid crystal display (LCD) or other suitable display device. Graphics display system 570 is configurable to receive textual and graphical information and processes the information for output to the display device.

Peripheral devices 580 may include any type of computer support device to add additional functionality to the computer system.

The components provided in the computer system 500 of FIG. 5 are those typically found in computer systems that may be suitable for use with embodiments of the present disclosure and are intended to represent a broad category of such computer components that are well known in the art. Thus, the computer system 500 of FIG. 5 can be a personal computer (PC), hand held computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX ANDROID, IOS, CHROME, and other suitable operating systems.

Some of the above-described functions may be composed of instructions that are stored on storage media (e.g., computer-readable medium). The instructions may be retrieved and executed by the processor. Some examples of storage media are memory devices, tapes, disks, and the like. The instructions are operational when executed by the processor to direct the processor to operate in accord with the technology. Those skilled in the art are familiar with instructions, processor(s), and storage media.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise an embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASHEPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the technology in the form disclosed. Many modifications and variations will be apparent to those of ordinary skill in the art without departing from the scope and spirit of the technology. Exemplary embodiments were chosen and described in order to best explain the principles of the present technology and its practical application, and to enable others of ordinary skill in the art to understand the technology for various embodiments with various modifications as are suited to the particular use contemplated.

Aspects of the present technology are described above with reference to flowchart illustrations and/or block diagrams of methods, apparatus (systems) and computer program products according to embodiments of the technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

While the present technology has been described in connection with a series of preferred embodiment, these descriptions are not intended to limit the scope of the technology to the particular forms set forth herein. It will be further understood that the methods of the technology are not necessarily limited to the discrete steps or the order of the steps described. To the contrary, the present descriptions are intended to cover such alternatives, modifications, and equivalents as may be included within the spirit and scope of the technology as defined by the appended claims and otherwise appreciated by one of ordinary skill in the art.

What is claimed is:

1. A method for migrating an email conversation to an instant message (IM) chat session, comprising:
receiving, by a processor, an email request from an email client via one or more email servers, wherein the email request comprises the email conversation and an address that initiates an action to instantiate the IM chat session of an IM service;
identifying, by the processor, a sender and one or more recipients from at least the email request and the email conversation;
verifying, by the processor, that the sender is authorized to create the IM chat session and that the one or more recipients are authorized to participate in the IM chat session;
transmitting, by the processor, an IM request to the IM service via an IM server to establish the IM chat session, the IM request having a plurality of IM service accounts associated with the sender and the one or more recipients, wherein the IM service invites the sender and the one or more recipients when the IM chat session is created;
receiving, by the IM server, responses from the sender and the one or more recipients to the invite; and
maintaining, by the IM server, the IM chat session for responding parties.

2. The method of claim 1, wherein the IM request further comprises a title of the IM chat session, the title determined from a subject of the email conversation.

3. The method of claim 1, further comprising:
parsing, by the processor, the email conversation to obtain a body of the email conversation, wherein the IM request comprises the body of the email conversation and the IM service adds the body of the email conversation to the IM chat session as a message when the IM chat session is created.

4. The method of claim 3, wherein the body of the email conversation is further parsed into a plurality of email replies, the IM service adding each email reply as a separate message to the IM chat session.

5. The method of claim 3, wherein the parsing the email conversation obtains one or more file attachments, and wherein the IM request comprises the one or more file attachments and the IM service adds a file transfer to the IM chat session for each of the one or more file attachments.

6. The method of claim 1, further comprising:
generating a guest IM service account for at least one of the one or more recipients that require a new IM service account, the guest IM service account being temporarily associated with the at least one of the one or more recipients.

7. The method of claim 1, further comprising:
receiving a second email request from the email client via the one or more email servers, the second email request having one or more additional emails associated with the email conversation; and
transmitting a second IM request to the IM service via the IM server, the second IM request having a body of each of the one or more additional emails, wherein the IM service adds each body to the IM chat session as an additional message.

8. The method of claim 1, wherein the email client comprises a plugin that automatically creates and sends the email request.

9. The method of claim 8, wherein the plugin sends the email request directly to the IM server.

10. The method of claim 1, wherein the address of the email request corresponds to the IM chat session such that subsequent email requests having the same address result in adding additional messages to the IM chat session.

11. The method of claim 1, wherein the address of the email request corresponds to a specific IM chat user, the sender being identified and verified based on the specific IM chat user as an author of the email conversation.

12. The method of claim 1, wherein the IM chat session is one of a plurality of IM chat sessions, each IM chat session of the plurality of IM chat sessions being associated with a different group of users.

13. The method of claim 1, wherein an IM client of at least one of the sender and the one or more recipients sends a command to the IM server to initiate an email, the command having at least one of one or more IM messages and one or more file attachments.

14. A system for migrating an email conversation to an instant message (IM) chat session comprising:
a processor; and
a memory coupled to the processor, the memory storing instructions which are executable by the processor to perform a method comprising:
receiving an email request from an email client via one or more email servers, wherein the email request comprises the email conversation and an address that initiates an action to instantiate the IM chat session of an IM service;
identifying a sender and one or more recipients from at least the email request and the email conversation;
verifying that the sender is authorized to create the IM chat session and that the one or more recipients are authorized to participate in the IM chat session;
transmitting an IM request to the IM service via an IM server to establish the IM chat session, the IM request having a plurality of IM service accounts associated with the sender and the one or more recipients, wherein the IM service invites the sender and the one or more recipients when the IM chat session is created;
receiving responses from the sender and the one or more recipients to the invite; and
maintaining the IM chat session for responding parties.

15. The system of claim 14, wherein the IM request further comprises a title of the IM chat session, the title determined from a subject of the email conversation.

16. The system of claim 14, further comprising parsing, by the processor, the email conversation to obtain a body of the email conversation, wherein the IM request comprises the body of the email conversation and the IM service adds the body of the email conversation to the IM chat session as a message when the IM chat session is created.

17. The system of claim 16, wherein the body of the email conversation is further parsed into a plurality of email replies, the IM service adding each email reply as a separate message to the IM chat session.

18. The system of claim 16, wherein the parsing the email conversation obtains one or more file attachments, and wherein the IM request comprises the one or more file attachments and the IM service adds a file transfer to the IM chat session for each of the one or more file attachments.

19. The system of claim 14, further comprising generating a guest IM service account for at least one of the one or more recipients that require a new IM service account, the guest IM service account being temporarily associated with the at least one of the one or more recipients.

20. The system of claim 14, further comprising receiving a second email request from the email client via the one or more email servers, the second email request having one or more additional emails associated with the email conversation; and transmitting a second IM request to the IM service via the IM server, the second IM request having a body of each of the one or more additional emails, wherein the IM service adds each body to the IM chat session as an additional message.

21. The system of claim 14, wherein the email client comprises a plugin that automatically creates and sends the email request.

22. The system of claim 21, wherein the plugin sends the email request directly to the IM server.

23. The system of claim 14, wherein the address of the email request corresponds to the IM chat session such that subsequent email requests having the same address result in adding additional messages to the IM chat session.

24. The system of claim 14, wherein the address of the email request corresponds to a specific IM chat user, the sender being identified and verified based on the specific IM chat user as an author of the email conversation.

25. The system of claim 14, wherein the IM chat session is one of a plurality of IM chat sessions, each IM chat session of the plurality of IM chat sessions being associated with a different group of users.

26. The system of claim 14, wherein an IM client of at least one of the sender and the one or more recipients sends a command to the IM server to initiate an email, the command having at least one of one or more IM messages and one or more file attachments.
